(19) United States
(12) Patent Application Publication
(10) Pub. No.: US 2014/0313123 A1
(43) Pub. Date: Oct. 23, 2014

(54) PROJECTOR FOR PROJECTING PATTERN FOR MOTION RECOGNITION AND MOTION RECOGNITION APPARATUS AND METHOD USING THE SAME

(71) Applicant: Electronics & Telecommunications Research Institute, Daejeon (KR)

(72) Inventors: Ji Young PARK, Daejeon (KR); Seung Woo NAM, Daejeon (KR); Jae Ho LEE, Daejeon (KR)

(73) Assignee: Electronics & Telecommunications Research Institute, Daejeon (KR)

(21) Appl. No.: 14/257,333

(22) Filed: Apr. 21, 2014

(30) Foreign Application Priority Data
Apr. 22, 2013 (KR) 10-2013-0044234

(51) Int. Cl. G06F 3/01

(52) U.S. Cl. CPC G06F 3/017
USPC 345/156

(57) ABSTRACT

Provided are a projector that projects a pattern for user motion recognition and a motion recognition apparatus and method using the projector. The projector includes a light generation unit, a light guide unit configured to guide light generated from the light generation unit in a predetermined direction, a collimating lens configured to collimate the light transmitted from the light guide unit, and a diffractive optical element (DOE) configured to generate the pattern using the light passing through the collimating lens.

In addition, the motion recognition apparatus includes a projector configured to project a pattern, a camera configured to photograph the projected pattern to generate an image including depth information, and a control unit configured to recognize a motion of a user using the image including the depth information and carry out a command corresponding to the recognized motion of the user.

### CLAIM FOR PRIORITY

This application claims priority to Korean Patent Application No. 10-2013-0044234 filed on Apr. 22, 2013 in the Korean Intellectual Property Office (KIPO), the entire contents of which are hereby incorporated by reference.

### BACKGROUND

1. Technical Field

Example embodiments of the present invention relate in general to a user motion recognition based-interface, and more specifically, to a projector for projecting a pattern for user motion recognition and a motion recognition apparatus and method using the projector.

2.Related Art

In recent years, motion recognition based-interface technology has attracted attention as new interface technology of a smart television (TV) capable of replacing a remote controller. In this instance, it is important to acquire high-quality three-dimensional (3D) information having high resolution and accuracy in order to increase accuracy of motion recognition, and such 3D information may be acquired through depth images.

A depth image may be acquired using an active acquisition method and a passive acquisition method. The active acquisition method may directly acquire depth information using a physical sensor device (infrared sensor, depth camera, and the like), whereas the passive acquisition method may calculate the depth information from images obtained through at least two cameras.

In particular, stereo matching, as one passive acquisition method, may acquire the depth information by searching a pixel of one image matching a pixel of the other image from two images of the same scene which are obtained from mutually different viewpoints.

However, the stereo matching has an advantage that it can extract the depth information from images photographed in a variety of conditions, but has problems that it cannot always ensure accuracy of the depth information and has high complexity. In addition, the stereo matching searches the depth information based on feature points in which there are changes in brightness values, and therefore it is difficult for the stereo matching to work in a relatively dark environment. As a result, it is difficult to apply the stereo matching to an interface for recognizing motion through a smart TV and the like.

As an example of the active acquisition method, a method in which a pattern is projected and depth information is calculated using information in which the projected pattern varies depending on a 3D distance may be given.

A camera of an input unit that receives the projected pattern information may generally include lens and an imaging sensor such as a CCD/CMOS sensor.

However, in such a device, it is important to reduce a thickness of a projector for projecting a pattern.

FIG. 1 illustrates an example of a general configuration of a projector for projecting a pattern so as to acquire a depth image according to the related art.

As shown in FIG. 1, the projector according to the related art has a problem in that it is difficult to reduce a thickness of the projector due to a focal distance required between a light source 10 and optical systems 20 and 30.

### SUMMARY

Accordingly, example embodiments of the present invention are provided to substantially obviate one or more problems due to limitations and disadvantages of the related art.

Example embodiments of the present invention provide a projector for projecting a pattern so as to recognize motions of a user.

Example embodiments of the present invention also provide a motion recognition apparatus that recognizes a motion of a user in order to carry out a command corresponding to the recognized motion of the user.

Example embodiments of the present invention also provide a motion recognition method that recognizes a motion of a user in order to carry out a command corresponding to the recognized motion of the user.

In some example embodiments, a projector that projects a pattern for motion recognition includes: a light generation unit; a light guide unit configured to guide light generated from the light generation unit in a predetermined direction; a collimating lens configured to collimate the light transmitted from the light guide unit; and a diffractive optical element (DOE) configured to generate the pattern using the light passing through the collimating lens.

Here, the light generation unit may use at least one of a lamp, a laser, and a light emitting diode (LED).

Also, the light guide unit may include at least one mirror that guides the light generated from the light generation unit in the predetermined direction.

Also, the light guide unit may further include an optical fiber that guides the light generated from the light generation unit in the predetermined direction.

Also, the light guide unit may guide the light generated from the light generation unit in a direction perpendicular to an advancing direction of the light generated from the light generation unit.

Also, the DOE may generate the pattern constituted of at least one of random dots, lines, and circles.

Also, the projector may be mounted in a display device together with at least one camera.

In other example embodiments, a motion recognition apparatus includes: a projector configured to project a pattern; a camera configured to photograph the projected pattern to generate an image including depth information; and a control unit configured to recognize a motion of a user using the image including the depth information and carry out a command corresponding to the recognized motion of the user.

Here, the projector may include a light generation unit, a light guide unit that guides light generated from the light generation unit in a predetermined direction, a collimating lens that collimates the light transmitted from the light guide unit, and a DOE that generates a pattern using the light passing through the collimating lens.

Also, the light guide unit may include at least one of a mirror and an optical fiber which guide the light generated from the light generation unit in the predetermined direction.

Also, the light guide unit may guide the light generated from the light generation unit in a direction perpendicular to an advancing direction of the light generated from the light generation unit.

Also, the motion recognition apparatus may be mounted in a display device to recognize a motion of a user who views an image displayed on the display device and to control the display device.

Also, the motion recognition apparatus may be mounted in a remote controller to recognize a motion of a user who views an image displayed on a display device controlled by the remote controller and to control the display device.

Also, the display device may be a smart television (TV).

In still other example embodiments, a motion recognition method includes: projecting a pattern using a projector; photographing the projected pattern through a camera; extracting depth information from the photographed pattern; and recognizing a motion of a user based on the depth information to execute a command corresponding to the recognized motion of the user.

Here, the projector may include a light generation unit, a light guide unit that guides light generated from the light generation unit in a predetermined direction, a collimating lens that collimates the light transmitted from the light guide unit, and a DOE that generates a pattern using the light passing through the collimating lens.

Also, the light guide unit may include at least one of a mirror and an optical fiber which guide the light generated from the light generation unit in the predetermined direction.

Also, the light guide unit may guide the light generated from the light generation unit in a direction perpendicular to an advancing direction of the light generated from the light generation unit.

Also, the recognizing of the motion may include recognizing the motion of the user who views an image displayed on a display device to execute the command corresponding to the recognized motion of the user in the display device.

### BRIEF DESCRIPTION OF DRAWINGS

Example embodiments of the present invention will become more apparent by describing in detail example embodiments of the present invention with reference to the accompanying drawings, in which:

FIG. 1 illustrates an example of a general configuration of a projector for projecting a pattern so as to acquire a depth image according to the related art;

FIG. 2 illustrates an example of a projector for projecting a pattern for motion recognition according to an embodiment of the present invention;

FIG. 3 illustrates an example of a projector for projecting a pattern for motion recognition according to another embodiment of the present invention;

FIG. 4 is a block diagram illustrating a configuration of a motion recognition apparatus according to an embodiment of the present invention;

FIG. 5 illustrates an example of a display device in which a motion recognition apparatus according to an embodiment of the present invention is mounted;

FIG. 6 illustrates an example of a remote controller in which a motion recognition apparatus according to an embodiment of the present invention is mounted; and

FIG. 7 is a flowchart illustrating a motion recognition method according to an embodiment of the present invention.

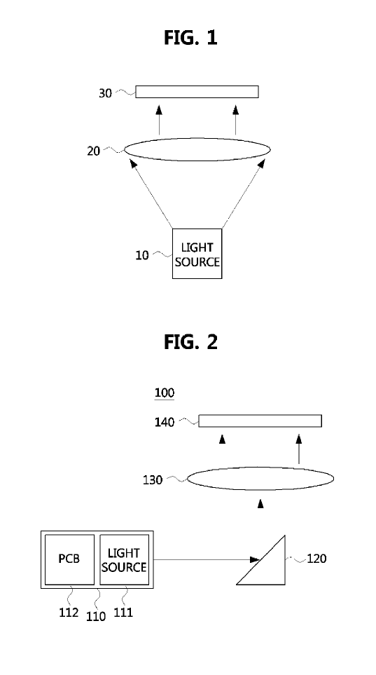

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, a three-dimensional (3D) depth camera that is used to acquire depth information of an image using left and right stereo cameras extracts and uses binocular disparity characteristics from an image photographed from mutually different viewpoints by cameras.

For example, a pattern is projected using a projector 100, images of the projected pattern are photographed, and a difference in location of the pattern between two photographed images is detected to extract a binocular disparity, thereby directly calculating a distance from a camera to an actual position of the pattern.

Here, it is most important that an image of the pattern acquired by the camera is accurately viewed, and for this, it is necessary to eliminate distortion or the like that can occur due to a camera lens and camera alignment. That is, due to restrictions in an operation of calculating a distance, calibration between the projector 100 and the camera or between cameras becomes important.

In addition, for miniaturization and slimming of a device that acquires depth information, it is important to reduce a physical space occupied by the projector 100 that projects a pattern.

Hereinafter, preferred embodiments of the present invention will be described in detail with reference to the accompanying drawings.

FIG. 2 illustrates an example of a projector 100 for projecting a pattern for motion recognition according to an embodiment of the present invention, and FIG. 3 illustrates an example of the projector 100 for projecting a pattern for motion recognition according to another embodiment of the present invention.

Referring to FIGS. 2 and 3, the projector 100 for projecting the pattern for motion recognition according to an embodiment of the present invention includes a light generation unit 110, light guide units 120 and 121, a collimating lens 130, and a diffractive optical element (DOE) 140.

When projecting a pattern so as to acquire depth information and acquiring the depth information by photographing the projected pattern, the projector 100 for projecting the pattern occupies a large physical space. Thus, in an apparatus or system that acquires the depth information, it is important to make a structure of the projector 100 for projecting the pattern slim

The light generation unit 110 may generate light using a lamp, a laser, or a light emitting diode (LED), and may use a combination of at least one of the lamp, the laser, and the LED. That is, the light generation unit 110 may generate the light using a light source 111 such as the lamp, the laser, or the LED.

The light generation unit 110 may include a heat dissipating plate that dissipates heat generated from the light source 111 and the like, and may also include a printed circuit board (PCB) 112 for driving the light source 111.

The light guide unit may guide light generated from the light generation unit 110 in a predetermined direction. The light guide unit may include a mirror 120 or an optical fiber to 121 which can guide the light generated from the light generation unit 110 in the predetermined direction.

Specifically, a direction of the light generated from the light generation unit 110 may be changed by an angle of the mirror 120. In addition, the light generated from the light generation unit 110 may be guided in various directions through the optical fiber 121.

In particular, the light guide unit may guide the light generated from the light generation unit 110 in a direction perpendicular to an advancing direction of the light generated from the light generation unit 110.

The light guide unit may transmit the light generated from the light generation unit 110 to the collimating lens 130. That is, the light guide unit may transmit the light generated from the light generation unit 110 to the collimating lens 130 which may be mounted in various positions.

The collimating lens 130 may collimate the light transmitted from the light guide unit. That is, the collimating lens 130 may cause the light transmitted from the light guide unit to advance in parallel.

The DOE 140 may generate a pattern using the light passing through the collimating lens 130. The DOE 140 may refer to an element using diffraction due to periodic structures. Here, the pattern may be constituted of random dots, lines, circles, or the like.

The projector 100 for projecting the pattern for motion recognition according to an embodiment of the present invention may be designed in conjunction with one or a plurality of cameras 200. That is, the projector 100 and at least one camera 200 may constitute a depth camera that extracts depth information.

In addition, the projector 100 for projecting the pattern for motion recognition may be mounted in a display device 500 such as a smart television (TV) together with the one or plurality of cameras 200.

Accordingly, the projector 100 mounted in the display device 500 may project a pattern to recognize a motion of a user.

For example, the camera 200 may photograph the pattern projected by the projector 100, depth information may be extracted from the photographed image to recognize a motion of a user, and the display device 500 or the like may be controlled based on the recognized motion of the user.

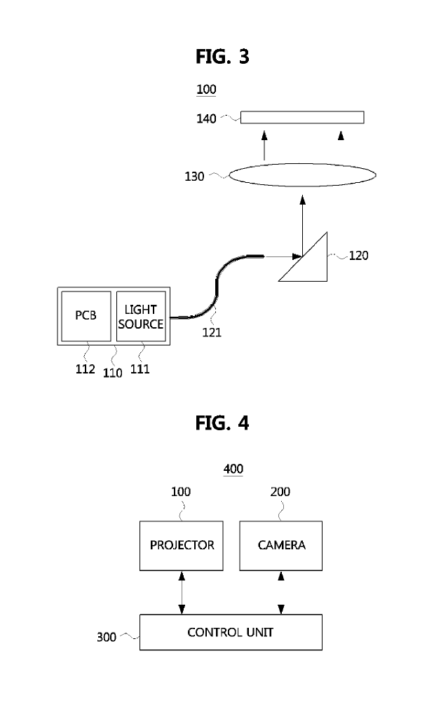

FIG. 4 is a block diagram illustrating a configuration of a motion recognition apparatus 400 according to an embodiment of the present invention.

Referring to FIG. 4, the motion recognition apparatus 400 according to an embodiment of the present invention includes a projector 100, a camera 200, and a control unit 300.

First, the motion recognition apparatus 400 according to an embodiment of the present invention may be mounted in a variety of devices or systems so that a motion of a user may be recognized and a command corresponding to the recognized motion of the user may be executed.

For example, the motion recognition apparatus 400 may be mounted in a display device 500 such as a smart TV to recognize a motion of a user who views an image displayed on the display device 500 and to control the display device 500.

However, the motion recognition apparatus 400 according to an embodiment of the present invention is not limitedly applied to the display device 500 such as the smart TV, but may be obviously applied to a variety of smart devices or systems.

The projector 100 may project a pattern. The pattern projected by the projector 100 may have various shapes. For example, the pattern may be constituted of random dots, lines, or circles. The projector 100 may use a lamp, a laser, or an LED as the light source 111.

Specifically, the projector 100 may include a light generation unit 110, a light guide unit, a collimating lens 130, and a DOE 140.

The light generation unit 110 may generate light using a lamp, a laser, or an LED, and may combine at least one of the lamp, the laser, and the LED.

The light guide unit may include a minor 120 or an optical fiber 121 so as to guide light generated from the light generation unit 110 in a predetermined direction.

For example, a direction of the light generated from the light generation unit 110 may be changed by an angle of the mirror 120 included in the light guide unit, or the light generated from the light generation unit 110 may be guided in various directions through the optical fiber 121 included in the light guide unit. In particular, the light guide unit may guide the light generated from the light generation unit 110 in a direction perpendicular to an advancing direction of the light generated from the light generation unit 110.

Accordingly, the light guide unit may transmit the light generated from the light generation unit 110 to the collimating lens 130 mounted in various positions.

The collimating lens 130 may collimate the light transmitted from the light guide unit, and the DOE 140 may generate a pattern using the light passing through the collimating lens 130.

In addition, the projector 100 may be controlled by the control unit 300 and operated in conjunction with the camera 200 through the control unit 300.

The camera 200 may generate an image including depth information by photographing the projected pattern. The camera 200 may be a CCD camera or a CMOS camera. In addition, a plurality of cameras may be utilized.

The control unit 300 may recognize a motion of a user using the image including the depth information generated by the camera 200 and carry out a command corresponding to the recognized motion of the user.

For example, when the motion recognition apparatus 400 is mounted in the display device 500, the control unit 300 may recognize a motion of a user who views an image displayed on the display device 500 and control the display device 500.

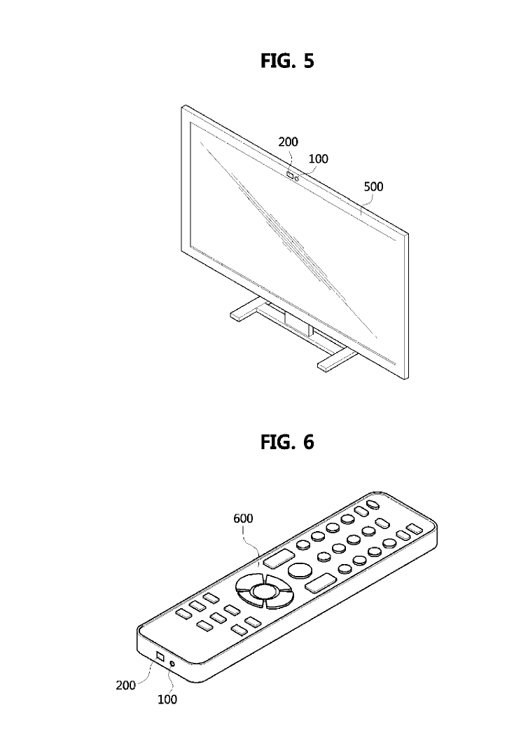

FIG. 5 illustrates an example of the display device 500 in which the motion recognition apparatus 400 according to an embodiment of the present invention is mounted, and FIG. 6 illustrates an example of a remote controller in which the motion recognition apparatus 400 according to an embodiment of the present invention is mounted.

Referring to FIGS. 5 and 6, the motion recognition apparatus 400 according to an embodiment of the present invention may be mounted in the display device 500 or a remote controller 600. In particular, the motion recognition apparatus 400 may be mounted in a slim smart TV.

The motion recognition apparatus 400 that has been miniaturized in accordance with an embodiment of the present invention may be mounted in a main body of the slim smart TV or a control means such as the remote controller 600. For example, the motion recognition apparatus 400 may be mounted on an upper side of the slim smart TV.

In addition, buttons are arranged on one surface of the remote controller 600 and the motion recognition apparatus 400 is mounted on the other surface thereof, and therefore the display device 500 or the like that is operated in conjunction with the remote controller 600 may be controlled by recognizing a user's hand motions.

However, the motion recognition apparatus 400 may be mounted in various positions in which a motion of a user can be accurately recognized, and does not have a particular limitation in its mounting position.

When a user approaches the display device 500 to view an image displayed by the display device 500, the motion recognition apparatus 400 may recognize the approach of the user to enable the display device 500 to be operated.

In addition, when a user who views an image displayed by the display device 500 makes a specific motion, the motion recognition apparatus 400 may recognize the specific motion and carry out a command corresponding to the specific motion in the display device 500.

For example, the motion recognition apparatus 400 may recognize a specific hand motion of a user and change a channel of the display device 500 or adjust a volume thereof.

In addition, the control unit 300 may set a command corresponding to a specific motion of the user in advance, or carry out a specific command in accordance with the specific motion of the user by setting of the user.

Meanwhile, the motion recognition apparatus 400 may be mounted in a robot or the like. A robot in which the motion recognition apparatus 400 according to an embodiment of the present invention is mounted may recognize a motion of a user and execute a command corresponding to the recognized motion of the user.

Furthermore, the motion recognition apparatus 400 may be mounted in home automation or building automation systems and the like.

Accordingly, the motion recognition apparatus 400 according to an embodiment of the present invention may be applied to various smart devices or systems which can execute commands based on the motions of the user.

Components of the motion recognition apparatus 400 according to an embodiment of the present invention have been arranged and described above, but at least two of the components may be integrated into a single component, or a single component may be divided into a plurality of components to perform corresponding functions. Even cases in which each component is integrated or divided are included within the scope of the present invention.

In addition, operations of the control unit 300 according to an embodiment of the present invention may be implemented as a computer-readable program or code in a computer-readable recording medium.

The computer-readable recording medium includes all types of recording devices in which data that can be read by a computer system can be stored.

In addition, the computer-readable recording medium may be distributed among computer systems connected via a network, so that the computer-readable program or code may be stored and executed in a decentralized fashion.

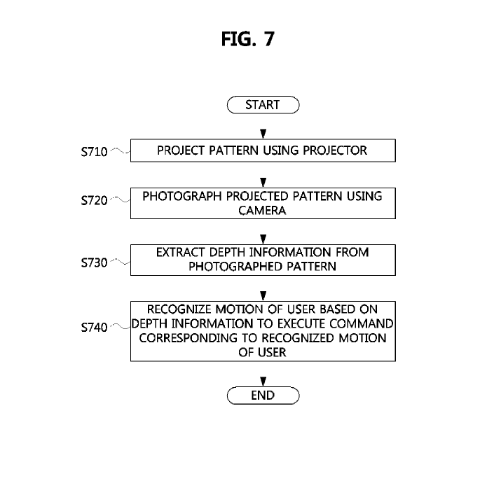

FIG. 7 is a flowchart illustrating a motion recognition method according to an embodiment of the present invention.

The motion recognition method according to an embodiment of the present invention may be performed using the projector 100 for projecting a pattern for the above-described motion recognition or the motion recognition apparatus 400.

Accordingly, the motion recognition method according to an embodiment of the present invention may be understood more clearly with reference to the descriptions of the projector 100 and the motion recognition apparatus 400.

Referring to FIG. 7, the motion recognition method according to an embodiment of the present invention includes step S710 of projecting a pattern, step S720 of photographing the projected pattern through a camera 200, step S730 of extracting depth information from the photographed pattern, and step S740 of recognizing a motion of a user based on the depth information to execute a command corresponding to the recognized motion of the user.

In step S710, a pattern may be projected using the projector 100. The projector 100 for projecting the pattern may include a light generation unit 110, a light guide unit, a collimating lens 130, and a DOE 140.

The light generation unit 110 may generate light using a lamp, a laser, or an LED, and may use a combination of at least one of the lamp, the laser, and the LED.

A direction of light generated from the light generation unit 110 may be changed by an angle of a mirror 120 included in the light guide unit, or the light generated from the light generation unit 110 may be radiated in various directions through an optical fiber 121 included in the light guide unit.

For example, the light guide unit may guide the light generated from the light generation unit 110 in a direction perpendicular to an advancing direction of the light generated from the light generation unit 110. The collimating lens 130 may collimate the light transmitted from the light guide unit, and the DOE 140 may generate a pattern using the light passing through the collimating lens 130.

In step S720, the projected pattern may be photographed through the camera 200.

The camera 200 may be a CCD camera or a CMOS camera, and may generate an image including depth information by photographing the projected pattern.

In step S730, the depth information may be extracted from the photographed pattern.

The pattern photographed using the camera 200 may include the depth information. Accordingly, the depth information may be extracted from the photographed pattern. Here, the depth information may refer to binocular disparity as information about a distance.

In step S740, a motion of a user may be recognized based on the depth information to execute a command corresponding to the recognized motion of the user.

For example, a display device 500 such as a smart TV may be controlled based on the motion of the user.

When a user approaches the display device 500 to view an image displayed by the display device 500, the approach of the user may be recognized to operate the display device 500.

In addition, when a user who views the image displayed by the display device 500 makes a specific motion, the specific motion may be recognized to carry out a command corresponding to the specific motion in the display device 500.

For example, a specific hand motion of a user may be recognized to change a channel of the display device 500 or adjust a volume thereof.

In addition, a command corresponding to a specific motion of the user may be set in advance, or a specific command may be executed in accordance with the specific motion of the user by setting of the user.

Meanwhile, the motion recognition method according to an embodiment of the present invention may be applied to a robot or the like. That is, a robot may recognize a motion of a user and execute a command corresponding to the recognized motion of the user.

Furthermore, the motion recognition method according to an embodiment of the present invention may be applied to home automation or building automation systems and the like.

Accordingly, the motion recognition method according to an embodiment of the present invention may be applied to various smart devices or systems which can execute commands based on the motions of the user.

In the projector 100 for projecting a pattern for motion recognition according to an embodiment of the present invention, a physical space occupied by the light source 111, the collimating lens 130, and the DOE 140 arranged in a line can be reduced by using the mirror 120 or the optical fiber 121.

Accordingly, the projector 100 according to an embodiment of the present invention can be effectively mounted in the slim display device 500 such as a smart TV.

In addition, the motion recognition apparatus 400 and method according to the present invention can be applied to various smart devices or systems that can recognize a motion of a user and execute a command corresponding to the recognized motion of the user.

That is, the motion recognition apparatus 400 and method according to the present invention can be applied to the smart device or system so that a desired command of a user can be effectively executed in the smart device or system through the motion of the user without a separate device such as a remote controller.

As described above, the projector according to the present invention can reduce a physical space occupied by the light source, the collimating lens, and the DOE arranged in a line, by using the mirror or the optical fiber.

In addition, the projector according to the present invention can be effectively mounted in a slim display device such as a smart TV.

In addition, the motion recognition apparatus and method according to the present invention can be applied to the smart device or system so that a desired command of a user can be effectively executed in the smart device or system through the motion of the user without a separate device such as a remote controller.

While the example embodiments of the present invention and their advantages have been described in detail, it should be understood that various changes, substitutions, and alterations may be made herein without departing from the scope of the invention as defined by the appended claims.

What is claimed is:

1. A projector that projects a pattern for motion recognition, comprising:
a light generation unit;
a light guide unit configured to guide light generated from the light generation unit in a predetermined direction;
a collimating lens configured to collimate the light transmitted from the light guide unit; and
a diffractive optical element (DOE) configured to generate the pattern using the light passing through the collimating lens.

2. The projector of claim 1, wherein the light generation unit uses at least one of a lamp, a laser, and a light emitting diode (LED).

3. The projector of claim 1, wherein the light guide unit includes at least one mirror that guides the light generated from the light generation unit in the predetermined direction.

4. The projector of claim 3, wherein the light guide unit further includes an optical fiber that guides the light generated from the light generation unit in the predetermined direction.

5. The projector of claim 1, wherein the light guide unit guides the light generated from the light generation unit in a direction perpendicular to an advancing direction of the light generated from the light generation unit.

6. The projector of claim 1, wherein the DOE generates the pattern constituted of at least one of random dots, lines, and circles.

7. The projector of claim 1, wherein the projector is mounted in a display device together with at least one camera.

8. A motion recognition apparatus, comprising:
a projector configured to project a pattern;
a camera configured to photograph the projected pattern to generate an image including depth information; and
a control unit configured to recognize a motion of a user using the image including the depth information and carry out a command corresponding to the recognized motion of the user.

9. The motion recognition apparatus of claim 8, wherein the projector includes a light generation unit, a light guide unit that guides light generated from the light generation unit in a predetermined direction, a collimating lens that collimates the light transmitted from the light guide unit, and a DOE that generates a pattern using the light passing through the collimating lens.

10. The motion recognition apparatus of claim 9, wherein the light guide unit includes at least one of a mirror and an optical fiber which guide the light generated from the light generation unit in the predetermined direction.

11. The motion recognition apparatus of claim 10, wherein the light guide unit guides the light generated from the light generation unit in a direction perpendicular to an advancing direction of the light generated from the light generation unit.

12. The motion recognition apparatus of claim 8, wherein the motion recognition apparatus is mounted in a display device to recognize a motion of a user who views an image displayed on the display device and to control the display device.

13. The motion recognition apparatus of claim 8, wherein the motion recognition apparatus is mounted in a remote controller to recognize a motion of a user who views an image displayed on a display device controlled by the remote controller and to control the display device.

14. The motion recognition apparatus of claim 12, wherein the display device is a smart television (TV).

15. A motion recognition method comprising:
projecting a pattern using a projector;
photographing the projected pattern through a camera;
extracting depth information from the photographed pattern; and
recognizing a motion of a user based on the depth information to execute a command corresponding to the recognized motion of the user.

16. The motion recognition method of claim 15, wherein the projector includes a light generation unit, a light guide unit that guides light generated from the light generation unit in a predetermined direction, a collimating lens that collimates the light transmitted from the light guide unit, and a DOE that generates a pattern using the light passing through the collimating lens.

17. The motion recognition method of claim 16, wherein the light guide unit includes at least one of a mirror and an optical fiber which guide the light generated from the light generation unit in the predetermined direction.

18. The motion recognition method of claim 17, wherein the light guide unit guides the light generated from the light generation unit in a direction perpendicular to an advancing direction of the light generated from the light generation unit.

19. The motion recognition method of claim 15, wherein the recognizing of the motion includes recognizing the motion of the user who views an image displayed on a display device to execute the command corresponding to the recognized motion of the user in the display device.
